(19) United States
(12) Patent Application Publication
(10) Pub. No.: US 2009/0189842 A1
(43) Pub. Date: Jul. 30, 2009

(54) BACKLIGHT CONTROL APPARATUS

(75) Inventors: Jui-Feng HUANG, Hsinchu City (TW); Lung-Pin Chung, Yuanli Township (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Industrial Technology Research Institute

(21) Appl. No.: 12/120,386

(22) Filed: May 14, 2008

Related U.S. Application Data
(60) Provisional application No. 61/023,095, filed on Jan. 24, 2008.

(51) Int. Cl. G09G 3/36

(52) U.S. Cl. 345/102

(57) ABSTRACT

A backlight control apparatus for controlling a backlight device for a liquid crystal display (LCD), the backlight device including a plurality of light-emitting components, the backlight control apparatus including: a synchronization unit to provide a synchronization signal; an image processing module to receive a video image signal representing a video image, the image processing module being configured to divide the video image into a plurality of block areas and generate a plurality of pulse-width modulation (PWM) data signals each corresponding to one of the plurality of block areas; a control module coupled to the synchronization unit and the image processing module, the control module being configured to generate a plurality of PWM signals based on the plurality of PWM data signals and the synchronization signal; and a driving module coupled to the control module, the driving module being configured to drive the backlight device based on the plurality of PWM signals.

### RELATED APPLICATIONS

This application is based upon and claims the benefit of priority from Provisional Application No. 61/023,095, filed Jan. 24, 2008, the entire contents of which are incorporated herein by reference.

### FIELD OF THE INVENTION

This invention pertains in general to a backlight control apparatus and, more particularly, to light-emitting diode (LED) backlight control apparatus.

### BACKGROUND OF THE INVENTION

Liquid crystal displays (LCDs) have been widely used in a variety of electronic devices, such as television sets, mobile phones, personal digital assistants (PDAs), etc. FIG. 1 illustrates a schematic block diagram of an LCD apparatus 100, disclosed in U.S. Pub. No. 2005/0237293. The LCD apparatus 100 comprises a signal input unit 102, a signal processor 104, a panel driver 106, an LCD panel 108, a controller 110, and a backlight unit 112 including a backlight driver 114 and a backlight array 116. A plurality of light-emitting devices in the backlight array 116 illuminate the LCD panel 108 with a plurality of colors arranged to have a predetermined pattern. The controller 110 controls the backlight driver 114 to adjust a white balance of a picture displayed on the LCD panel 108. The backlight driver 114 drives each light-emitting device to emit light and to adjust light intensity.

Typically, an LCD includes a backlight device, such as the backlight array 116 of the LCD apparatus 100, operating as a light source to provide illumination such that images may be displayed on the LCD. A conventional backlight device may use a cold cathode fluorescent lamp (CCFL) as the light source. However, a light output of the CCFL may decrease in cold conditions. In addition, life expectancy of the CCFL may be reduced due to vibration.

Recently, there has been great interest in using light-emitting diodes (LEDs) as the light source in the backlight device. LEDs may offer the advantages of a longer lifetime and resistance to vibration. Intensity of light emitted by LEDs can also be controlled by controlling a current flowing therethrough. For example, a conventional direct current (DC) driving unit may be used to control the LED backlight device to improve light-emitting efficiency and light balance. However, the DC driving unit may increase manufacturing complexity of the LCD and manufacturing cost.

### SUMMARY OF THE INVENTION

In accordance with the invention, there is provided a backlight control apparatus for controlling a backlight device for a liquid crystal display (LCD), the backlight device including a plurality of light-emitting components, the backlight control apparatus comprising: a synchronization unit to provide a synchronization signal; an image processing module to receive a video image signal representing a video image, the image processing module being configured to divide the video image into a plurality of block areas and generate a plurality of pulse-width modulation (PWM) data signals each corresponding to one of the plurality of block areas; a control module coupled to the synchronization unit and the image processing module, the control module being configured to generate a plurality of PWM signals based on the plurality of PWM data signals and the synchronization signal; and a driving module coupled to the control module, the driving module being configured to drive the backlight device based on the plurality of PWM signals.

Also in accordance with the invention, there is provided a method for controlling a backlight device to display a video image on a liquid crystal display (LCD), the backlight device including a plurality of light-emitting components, the method comprising: dividing the video image into a plurality of block areas; determining a plurality of brightness values each for one of the plurality of block areas; generating a plurality of pulse-width modulation (PWM) signals each corresponding to one of the plurality of block areas, based on the plurality of brightness values; and controlling the backlight device based on the plurality of PWM signals, wherein each of the plurality of PWM signals controls ones of the plurality of light-emitting components corresponding to one of the plurality of block areas.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and, together with the description, serve to explain the principles of the invention.

FIG. 1 illustrates a schematic block diagram of an LCD apparatus according to the prior art.

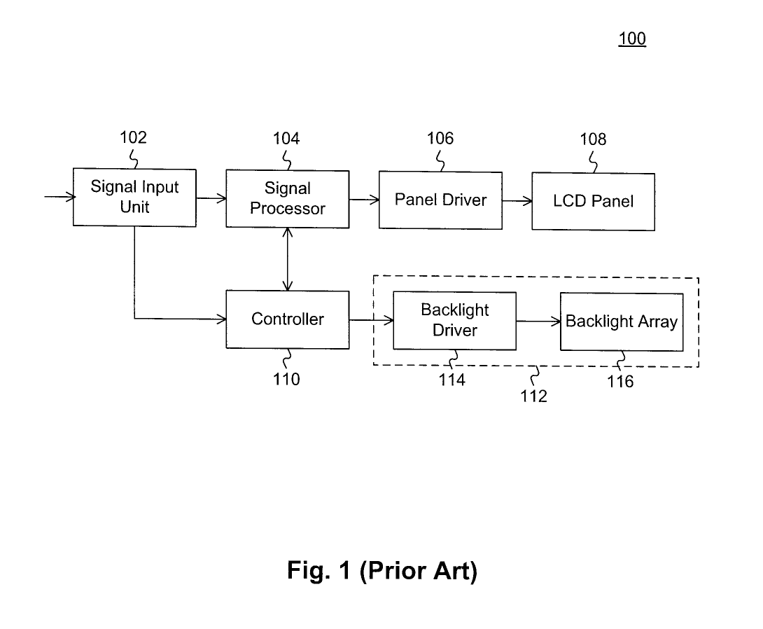

FIG. 2 illustrates a schematic block diagram of a backlight control apparatus, according to an exemplary embodiment.

FIG. 3 illustrates a schematic block diagram of a synchronization unit, according to an exemplary embodiment.

FIG. 4A illustrates a schematic block diagram of an image processing module, according to an exemplary embodiment.

FIG. 4B illustrates a schematic block diagram of an image converting unit, according to an exemplary embodiment.

FIG. 4C illustrates a schematic block diagram of a calculation unit, according to an exemplary embodiment.

FIG. 5 illustrates a schematic block diagram of a control module, according to an exemplary embodiment.

FIG. 6A illustrates a schematic block diagram of a driving module, according to an exemplary embodiment.

FIG. 6B illustrates a circuit diagram of a driving unit, according to an exemplary embodiment.

FIG. 7 illustrates a flow chart of a method for a backlight control apparatus to control a backlight device, according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention as recited in the appended claims.

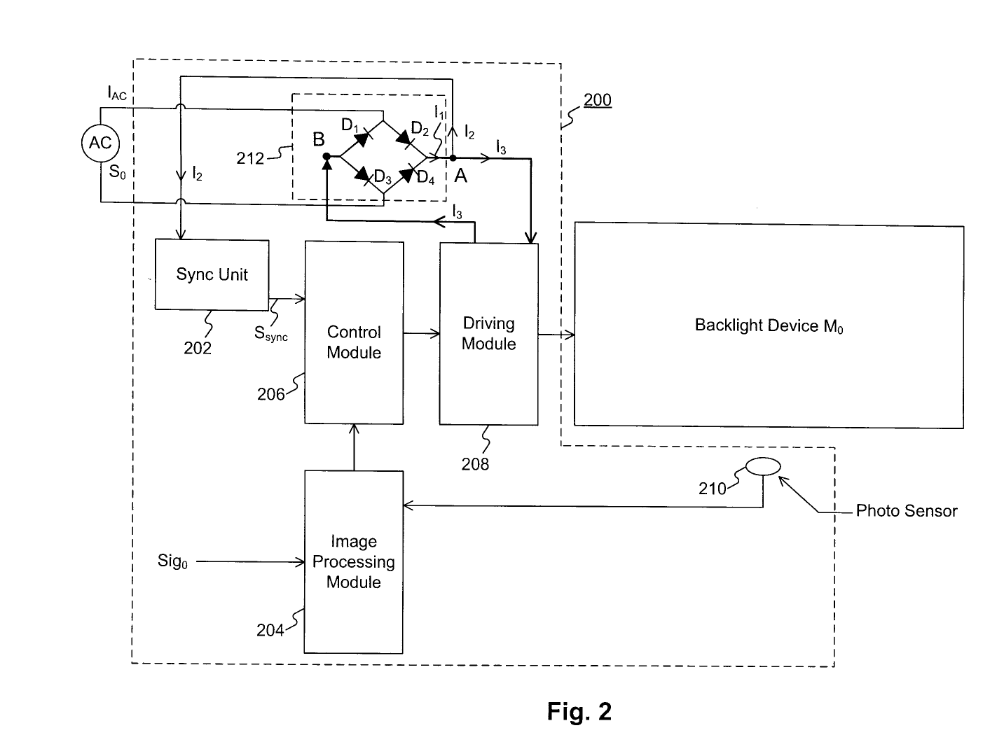

FIG. 2 illustrates a schematic block diagram of a backlight control apparatus 200, according to an exemplary embodiment. The backlight control apparatus 200 is configured to control a backlight device M₀ including a plurality of light-emitting components for providing illumination for an LCD. The backlight control apparatus 200 may include a synchronization (Sync) unit 202, an image processing module 204, a control module 206, and a driving module 208. The backlight control apparatus 200 may further include a photo sensor 210 to sense intensity of light emitted by the backlight device M₀.

Solely for the purpose of illustration, it is assumed that the backlight device M₀ includes a plurality of light-emitting diodes (LEDs). The LEDs may be single-color LEDs such as white LEDs, or multi-color LEDs such as a combination of red LEDs, green LEDs, and blue LEDs. The backlight device M₀ may emit light to illuminate an LCD such that a video image Im₀ may be displayed on the LCD.

In exemplary embodiments consistent with the present invention, the backlight control apparatus 200 is configured to be powered by an alternating current (AC) power source S₀. The power source S₀ may have an output voltage amplitude range, for example, between 110 V and 220 V, and provide an alternating current I_{AC}. Accordingly, the backlight control apparatus 200 may further include an alternating current rectifying circuit 212 shown in FIG. 2. For example, the alternating current rectifying circuit 212 may include first, second, third, and fourth diodes D1, D2, D3, and D4, respectively. The alternating current rectifying circuit 212 may rectify the alternating current I_{AC} provided by the AC power source S₀ to generate a rectified current I₁.

The synchronization unit 202 is coupled to the alternating current rectifying circuit 212 and configured to provide a synchronization signal S_{sync} such as a 120 Hz periodic pulse signal based on a current I₂, which is a first part of the current I₁.

The image processing module 204 may receive a video image signal Sig₀ representing the video image Im₀. The image processing module 204 is configured to divide the video image Im₀ into a plurality of block areas Block-1, Block-2, . . . , Block-N. In one exemplary embodiment, the image processing module 204 may receive a feedback signal from the photo sensor 210 when the LCD is turned on, and determine at least one calibration value, which will be described below. The image processing module 204 is also configured to generate a plurality of calibrated pulse-width modulation (PWM) data signals PWMDATA-1, PWMDATA-2, . . . , PWMDATA-N, respectively corresponding to the block areas Block-1, Block-2, . . . , Block-N of the video image Im₀, based on the at least one calibration value.

The control module 206 is coupled to the synchronization unit 202 to receive the synchronization signal S_{sync} and coupled to the image processing module 204 to receive the PWM data signals PWMDATA-1, PWMDATA-2, . . . , PWMDATA-N. The control module 206 is configured to generate a plurality of PWM signals PWM-1, PWM-2, . . . , PWM-N based on the PWM data signals PWMDATA-1, PWMDATA-2, . . . , PWMDATA-N and the synchronization signal S_{sync}. The generated PWM signals PWM-1, PWM-2, . . . , PWM-N have duty cycle values respectively associated with values of the PWM data signals PWMDATA-1, PWMDATA-2, . . . , PWMDATA-N.

The driving module 208 is coupled to the control module 206 to receive the PWM signals PWM-1, PWM-2, . . . , PWM-N and coupled to the alternating current rectifying circuit 212 to receive power. For example, a current I₃, which is a second part of the current I₁, may be provided to the driving module 208. The driving module 208 is configured to drive the backlight device M₀ based on the PWM signals PWM-1, PWM-2, . . . , PWM-N.

For example, the LEDs in the backlight device M₀ may be divided into a plurality of LED arrays LEDs-1, LEDs-2, . . . , LEDs-N, respectively corresponding to the block areas Block-1, Block-2, . . . , Block-N. The LED arrays LEDs-i (i=1, 2, . . . , N) may be arranged to have a predetermined pattern. For example, each of the LED arrays LEDs-1, LEDs-2, . . . , LEDs-N may physically align with the portion of the LCD panel displaying Block-1, Block-2, . . . , Block-N, respectively, of the video image Im₀. In addition, the LED arrays LEDs-i may each include a string of white LEDs, if the LED backlight device M₀ uses single-color LEDs. Each of the LED arrays LEDs-i may also include a first string of red LEDs, a second string of green LEDs, and a third string of blue LEDs, if the LED backlight device M₀ uses multi-color LEDs. The driving module 208 drives the LED arrays LEDs-1, LEDs-2, . . . , LEDs-N, based on the PWM signals PWM-1, PWM-2, . . . , PWM-N, respectively.

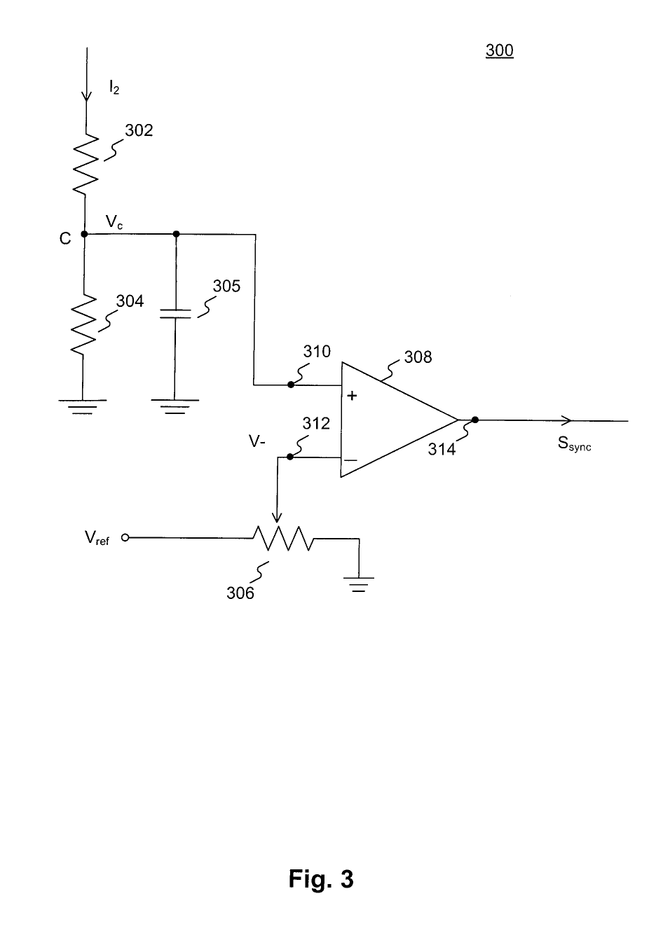

FIG. 3 illustrates a schematic block diagram of a synchronization unit 300, according to an exemplary embodiment. The synchronization unit 300 is an exemplary implementation of the synchronization unit 202 in FIG. 2, and may include a filter circuit having first and second resistors 302 and 304 coupled in series, and a capacitor 305 coupled in parallel with the resistor 304. The synchronization unit 300 also includes a variable resistor 306 and a comparator 308. The comparator 308 includes first and second input terminals 310 and 312, and an output terminal 314. The synchronization unit 300 is configured to generate the synchronization signal S_{sync} based on the current I₂ provided by the alternating current rectifying circuit 212 (FIG. 2).

For example, the current I₂ flows through the first and second resistors 302 and 304 and the capacitor 305, and causes a voltage drop across the resistor 302. Accordingly, a first voltage V_{C} at a node C between the resistors 302 and 304 is applied at the first input terminal 310 of the comparator 308. In addition, a second voltage V− is applied at the second input terminal 312 of the comparator 308. The second voltage V− may be varied based on a reference voltage V_{ref} and the variable resistor 306. Based on the voltages V_{C} and V−, the comparator 308 may generate the synchronization signal S_{sync}.

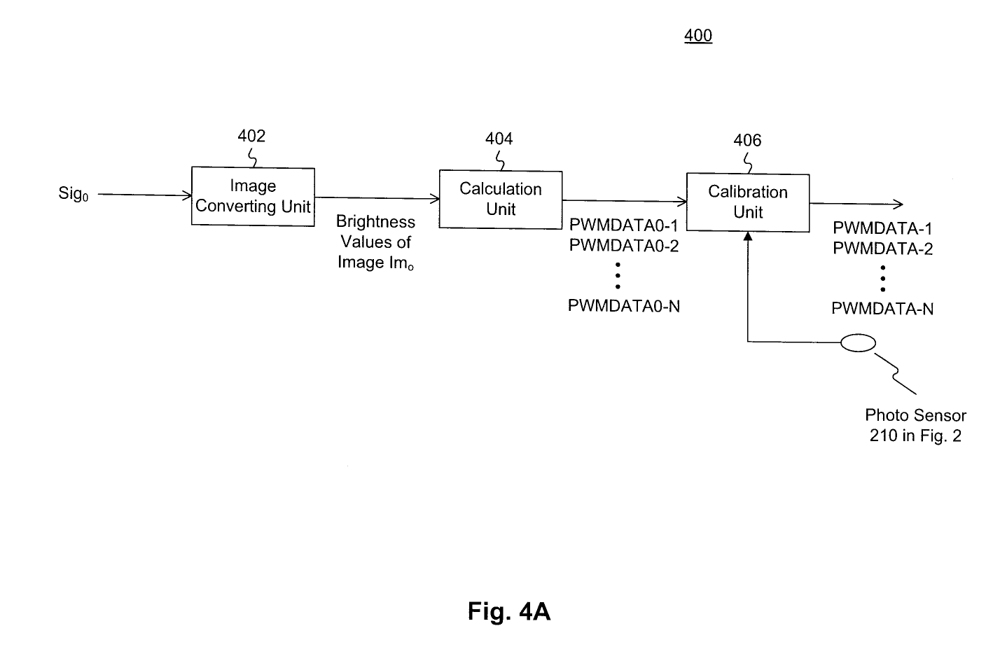

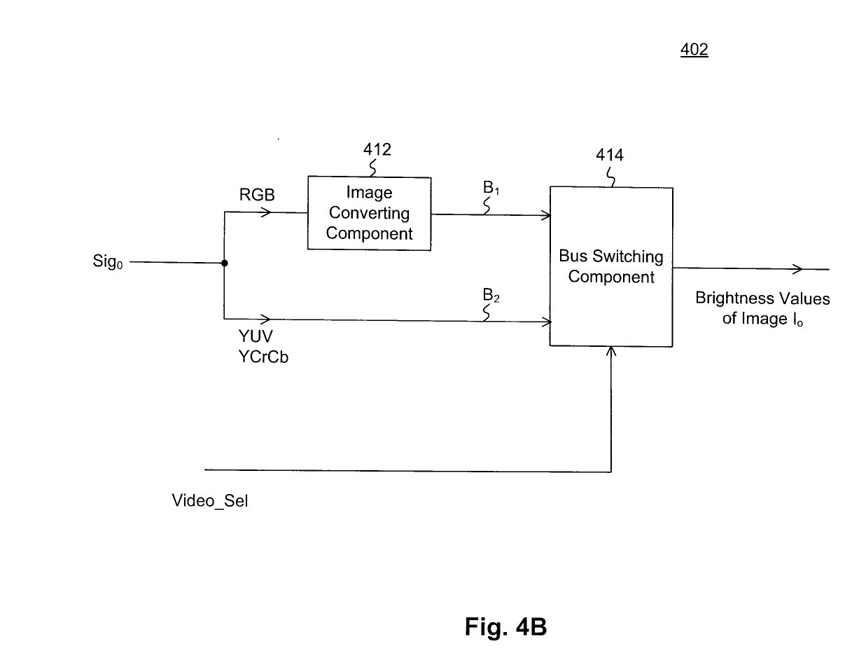

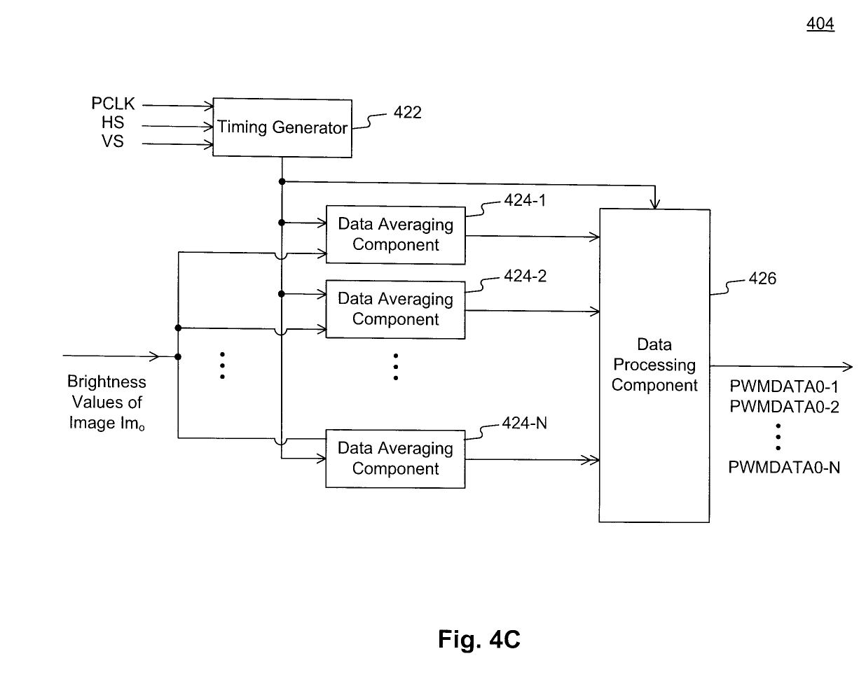

FIG. 4A illustrates a schematic block diagram of an image processing module 400, according to an exemplary embodiment. The image processing module 400 is an exemplary implementation of the image processing module 204 in FIG. 2, and may include an image converting unit 402, a calculation unit 404, and a calibration unit 406. The image processing module 400 is configured to convert the video image signal Sig₀ representing the video image Im₀ into the calibrated PWM data signals PWMDATA-1, PWMDATA-2, . . . , PWMDATA-N, respectively corresponding to the block areas Block-1, Block-2, . . . , Block-N of the video image Im₀.

Typically, a video image signal may comply with a standard and use a color format determined by the standard. For example, a video image signal complying with a television broadcast standard, such as the phase alternating line (PAL) standard or the national television system committee (NTSC) standard, may use a YUV color format. The video image signal using the YUV color format is a YUV signal including a Y component, a U component, and a V component. Also, for example, a video image signal complying with other standards may use a YCbCr format or an RGB format, and respectively be a YCbCr signal including a Y component, a Cb component, and a Cr component, or an RGB signal including an R component, a G component, and a B component. The Y component of the YUV or YCbCr signal indicates a brightness value of each pixel of an image represented by the YUV or YCbCr signal. For an RGB signal, the following Equation (1)

Y=0.299×R+0.587×G+0.114×B Equation (1)

may be used to calculate a brightness value of each pixel of an image represented by the RGB signal. Solely for the purpose of illustration, it is assumed that the video image signal Sig₀ inputted to the image processing unit 400 may be an RGB signal, a YUV signal, or a YCbCr signal. However, the video image signal Sig₀ may use any color format that includes image brightness information.

In one exemplary embodiment, the image converting unit 402 is configured to convert the video image signal Sig₀ into a plurality of brightness values each corresponding to a pixel of the video image Im₀, i.e., the brightness values of the video image Im₀.

FIG. 4B illustrates a schematic block diagram of the image converting unit 402, according to an exemplary embodiment. Referring to FIG. 4B, the image converting unit 402 includes an image converting component 412 and a bus switching component 414. The image converting component 412 may convert R, G, and B components of the video image signal Sig₀ to the brightness values of the video image Im₀ based on Equation (1), if the input video image signal Sig₀ is an RGB signal, and send the converted brightness values to the bus switching component 414 via a first bus B1. If the input video image signal is a YUV or YCbCr signal, the input video image signal Sig₀ may be sent to the bus switching component 414 via a second bus B2. The Y component of the video image signal Sig₀ indicates the brightness values of the video image Im₀.

The bus switching component 414 is configured to select data including the brightness values of the video image Im₀ from the first or second buses B1 or B2, based on a selection signal Video_Sel indicating the type of the video image signal Sig₀. For example, if the selection signal Video_Sel indicates the video image signal Sig₀ is the RGB signal, the bus switching component 414 selects the data from the first bus B1. Also, for example, if the selection signal Video_Sel indicates the video image signal Sig₀ is the YUV or YCbCr signal, the bus switching component 414 selects the data from the second bus B2. The bus switching component 414 may then send the brightness values of the video image Im₀ to the calculation unit 404 (FIG. 4A).

Referring back to FIG. 4A, the calculation unit 404 is configured to receive the brightness values of the video image Im₀ from the image converting unit 402 and to divide the video image Im₀ into the N block areas noted above. For example, the calculation unit 404 may divide the video image Im₀ into N1×N2 block areas, i.e., N=N1×N2, where N1 is the number of blocks in a row and N2 is the number of blocks in a column of the video image Im₀. In addition, the calculation unit 404 is configured to convert the brightness values of the video image Im₀ to a plurality of uncalibrated PWM data signals PWMDATA0-1, PWMDATA0-2, . . . , PWMDATA0-N, respectively corresponding to the block areas Block-1, Block-2, . . . , Block-N of the video image Im₀.

FIG. 4C illustrates a schematic block diagram of the calculation unit 404, according to an exemplary embodiment. Referring to FIG. 4C, the calculation unit 404 may include a timing generator 422, a plurality of data averaging components 424-1, 424-2, . . . , 424-N (N is the total number of the block areas of the video image Im₀), and a data processing component 426. The calculation unit 404 may further include a memory device such as a synchronous dynamic random access memory (SDRAM) device (not shown in FIG. 4C) to facilitate performance of calculations by the calculation unit 404.

The timing generator 422 is configured to generate a timing signal for the data averaging components 424-1, 424-2, . . . , 424-N and the data processing component 426, based on a pixel clock (PCLK) signal, a horizontal synchronization (HS) signal, and a vertical synchronization (VS) signal. For example, the PCLK signal, the HS signal, and the VS signal may be generated by a decoder circuit (not shown) based on the video image signal Sig₀. Based on the timing signal and the brightness values of the video image Im₀, the data averaging components 424-1, 424-2, . . . , 424-N may divide the video image Im₀ into the N block areas, and the data averaging component 424-i (i=1, 2, . . . , N) may calculate an average brightness value for the block area Block-i, and send the calculated average brightness value to the data processing component 426.

In one exemplary embodiment, the data processing component 426 further processes the average brightness values respectively received from the data averaging components 424-1, 424-2, . . . , 424-N. For example, the data processing component 426 may generate a histogram for the average brightness values. The data processing component 426 may then perform normalization and/or distribution compensation of the generated histogram to adjust each of the received average brightness values. The adjusted average brightness values may then be used to generate the uncalibrated PWM data signals PWMDATA0-1, PWMDATA0-2, . . . , PWMDATA0-N.

Usually, LEDs that have the same color in a backlight device may have an approximately equal chroma or chromaticity value. For example, if the backlight device M₀ (FIG. 2) uses single-color LEDs such as white LEDs, the white LEDs in the backlight device M₀ may each have approximately the same chroma value (x, y), where (x, y) is a chromaticity coordinate value defined in the International Commission on Illumination (CIE) 1931 color space. A first look-up table based on the chroma value (x, y) of the white LEDs may be stored in the calculation unit 404. The first look-up table includes a conversion relation from a plurality of brightness values to a plurality of duty cycle values with each of the plurality of brightness values corresponding to each of the duty cycle values. This enables the data processing component 426 to generate the uncalibrated PWM data signals PWMDATA0-1, PWMDATA0-2, . . . , PWMDATA0-N based on the first look-up table. For example, the data processing component 426 may convert the adjusted average brightness value for the block area Block-i to the uncalibrated PWM data signal PWMDATA0-i by looking up the adjusted average brightness value in the first look-up table to obtain the corresponding uncalibrated PWM data signal.

Also for example, if the backlight device M₀ (FIG. 2) uses multi-color LEDs such as red, green, and blue LEDs, the red LEDs in the backlight device M₀ may each have approximately the same chroma value (x_{R}, y_{R}), the green LEDs in the backlight device M₀ may have approximately the same chroma value (x_{G}, y_{G}), and the blue LEDs in the backlight device M₀ may have approximately the same chroma value (x_{B}, y_{B}), where each of (x_{R}, y_{R}), (x_{G}, y_{G}), and (x_{B}, y_{B}) is a chromaticity coordinate value defined in the CIE 1931 color space. A second look-up table based on the chroma value (x_{R}, y_{R}) of the red LEDs, the chroma value (x_{G}, y_{G}) of the green LEDs, and the chroma value (x_{B}, y_{B}) of the blue LEDs may be stored in the data processing component 426. The second look-up table includes a conversion relation from a plurality of red brightness values to a first plurality of duty cycle values with each of the plurality of red brightness values corresponding to each of the first plurality of duty cycle values, a second conversion relation from a plurality of green brightness values to a second plurality of duty cycle values with each of the plurality of green brightness values corresponding to each of the second plurality of duty cycle values, and a third conversion relation from a plurality of blue brightness values to a third plurality of duty cycle values with each of the plurality of blue brightness values corresponding to each of the third plurality of duty cycle values. This enables the data processing component 426 to generate the uncalibrated PWM data signals PWMDATA0-1, PWMDATA0-2, . . . , PWMDATA0-N based on the second look-up table.

In one exemplary embodiment, the data processing component 426 may calculate a red brightness value L_{R}, a green brightness value L_{G}, and a blue brightness value L_{B} for the block area Block-i of the video image Im₀ based on Equations (2):

$$( 1 - \frac{{y}_{w}}{{y}_{R}} ) {L}_{R} + ( 1 - \frac{{y}_{w}}{{y}_{G}} ) {L}_{G} + ( 1 - \frac{{y}_{w}}{{y}_{B}} ) {L}_{B} = 0 \\ ( \frac{{x}_{R} - {x}_{w}}{{y}_{R}} ) {L}_{R} + ( \frac{{x}_{G} - {x}_{w}}{{y}_{G}} ) {L}_{G} + ( \frac{{x}_{B} - {x}_{w}}{{y}_{B}} ) {L}_{B} = 0 , \\ {L}_{R} + {L}_{G} + {L}_{B} = {L}_{w} \qquad Equations ( 2 )$$

where x_{W} and y_{W} are backlight parameters set by a user to adjust chroma of an image displayed on the LCD, (x_{R}, y_{R}) is the chroma value of the red LEDs, (x_{G}, y_{G}) is the chroma value of the green LEDs, (x_{B}, y_{B}) is the chroma value of the blue LEDs, and L_{W} is the adjusted average brightness value for the block area Block-i determined by the data processing component 426, as previously described.

The data processing component 426 then generates the uncalibrated PWM data signals PWMDATA0-1, PWMDATA0-2, . . . , PWMDATA0-N based on the second look-up table. For example, the data processing component 426 converts the red, green, and blue brightness values L_{R}, L_{G}, and L_{B} for the block area Block-i to first, second, and third signal components R-PWMDATA0-i, G-PWMDATA0-i, and B-PWMDATA0-i of the uncalibrated PWM data signal PWMDATA0-i, respectively, by looking up the adjusted average brightness values in the second look-up table to obtain the corresponding uncalibrated PWM data signals.

Referring back to FIG. 4A, the calibration unit 406 is configured to receive the uncalibrated PWM data signals PWMDATA0-1, PWMDATA0-2, . . . , PWMDATA0-N from the calculation unit 404 and perform calibration thereof. In one exemplary embodiment, the calibration unit 406 receives the feedback signal from the photo sensor 210 (FIG. 2) when the LCD is turned on. The calibration unit 406 may further determine at least one calibration value based on the feedback signal indicating the intensity of the light emitted by the backlight device M₀ (FIG. 2). The calibration unit 406 may then calibrate the uncalibrated PWM data signals PWMDATA0-1, PWMDATA0-2, . . . , PWMDATA0-N, based on the calibration value, and generate the calibrated PWM data signals PWMDATA-1, PWMDATA-2, . . . , PWMDATA-N.

For example, if the backlight device M₀ (FIG. 2) uses single-color LEDs such as white LEDs, the calibration unit 406 may generate a calibration value by comparing the intensity of the light emitted by the white LEDs to an ideal intensity when the LCD is turned on. If the intensity of the light emitted by the white LEDs is larger than the ideal intensity, the calibration unit 406 may generate the calibrated PWM data signal PWMDATA-i by decreasing a value of the uncalibrated PWM data signal PWMDATA0-i based on the calibration value. If the intensity of the light emitted by the white LEDs is smaller than the ideal intensity, e.g., due to LED light decay, the calibration unit 406 may generate the calibrated PWM data signal PWMDATA-i by increasing the value of the uncalibrated PWM data signal PWMDATA0-i based on the calibration value.

Also, for example, if the backlight device M₀ (FIG. 2) uses multi-color LEDs such as red, green, and blue LEDs, the calibration unit 406 may generate first, second, and third calibration values respectively for the red, green, and blue LEDs by comparing the intensity of the light respectively emitted by the red, green, and blue LEDs to an ideal intensity. Similar to the description above in connection with the white LEDs, the calibration unit 406 may increase or decrease values of the signal components R-PWMDATA0-i, G-PWMDATA0-i, and B-PWMDATA0-i of the uncalibrated PWM data signal PWMDATA0-i, respectively based on the first, second, and third calibration values. The calibrated PWM data signal PWMDATA-i for the multi-color LEDs may also include first, second, and third signal components R-PWMDATA-i, G-PWMDATA-i, and B-PWMDATA-i.

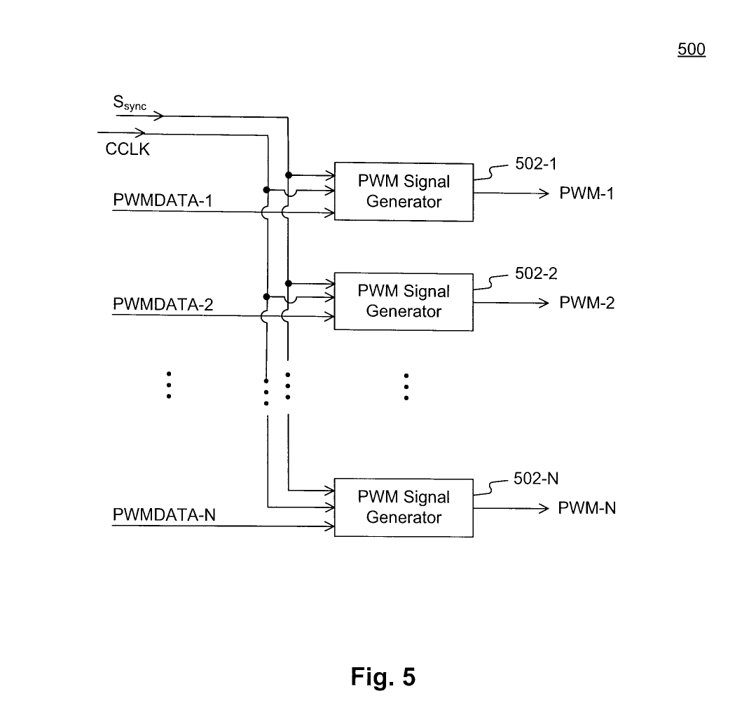

FIG. 5 illustrates a schematic block diagram of an LED control module 500, according to an exemplary embodiment. The LED control module 500 is an exemplary implementation of the control module 206 in FIG. 2, and may include a plurality of PWM signal generators 502-1, 502-2, . . . , 502-N (N is the total number of the block areas of the video image Im₀). The control module 500 is configured to generate a plurality of PWM signals PWM-1, PWM-2, . . . , PWM-N based on a clock signal CCLK, the calibrated PWM data signals PWMDATA-1, PWMDATA-2, . . . , PWMDATA-N received from the image processing module 204, and the synchronization signal S_{sync} received from the synchronization unit 202 (FIG. 2). In one exemplary embodiment, the signal CCLK may be used to drive the backlight device M₀ (FIG. 2) if there is no input video image signal during operation.

For example, if the backlight device M₀ (FIG. 2) uses single-color LEDs such as white LEDs, the PWM signal generator 502-i (i=1, 2, . . . , N) may include a counter Counter-i. The PWM signal generator 502-i may set an initial count value Vᵢ of the counter Counter-i to zero. When the PWM signal generator 502-i receives a pulse of the synchronization signal S_{sync}, the counter Counter-i begins to increment the count value Vᵢ. Before the count value Vᵢ reaches a value of the PWM data signal PWMDATA-i, the PWM signal generator 502-i continually outputs the PWM signal PWM-i with a high level. When the count value Vᵢ reaches the value of the PWM data signal PWMDATA-i, the PWM signal generator 502-i changes the PWM signal PWM-i to a low level, and resets the count value Vᵢ to zero. The PWM signal generator 502-i continually outputs the PWM signal PWM-i with the low level until receiving a next pulse of the synchronization signal S_{sync}. Accordingly, the PWM signal generator 502-i generates the PWM signal PWM-i having a duty cycle value associated with the value of the calibrated PWM data signal PWMDATA-i. The PWM signal PWM-i so generated is then sent to the driving module 208 (FIG. 2) to drive the LED array LEDs-i.

Also, for example, if the backlight device M₀ uses multi-color LEDs such as red, green, and blue LEDs, the PWM signal generator 502-i may have first, second, and third counters Counter1-i, Counter2-i, and Counter3-i, respectively for the first, second, and third signal components R-PWMDATA-i, G-PWMDATA-i, and B-PWMDATA-i of the calibrated PWM data signal PWMDATA-i. Similar to the description above in connection with the backlight device M₀ using single-color LEDs, the PWM signal generator 502-i may generate the PWM signal PWM-i including first, second, and third signal components R-PWM-i, G-PWM-i, and B-PWM-i having duty cycle values respectively corresponding to values of the first, second, and third signal components R-PWMDATA-i, G-PWMDATA-i, and B-PWMDATA-i. The PWM signal components R-PWM-i, G-PWM-i, and B-PWM-i so generated are sent to the driving module 208 (FIG. 2) to respectively drive the red, green, and blue LED strings in the LED array LEDs-i.

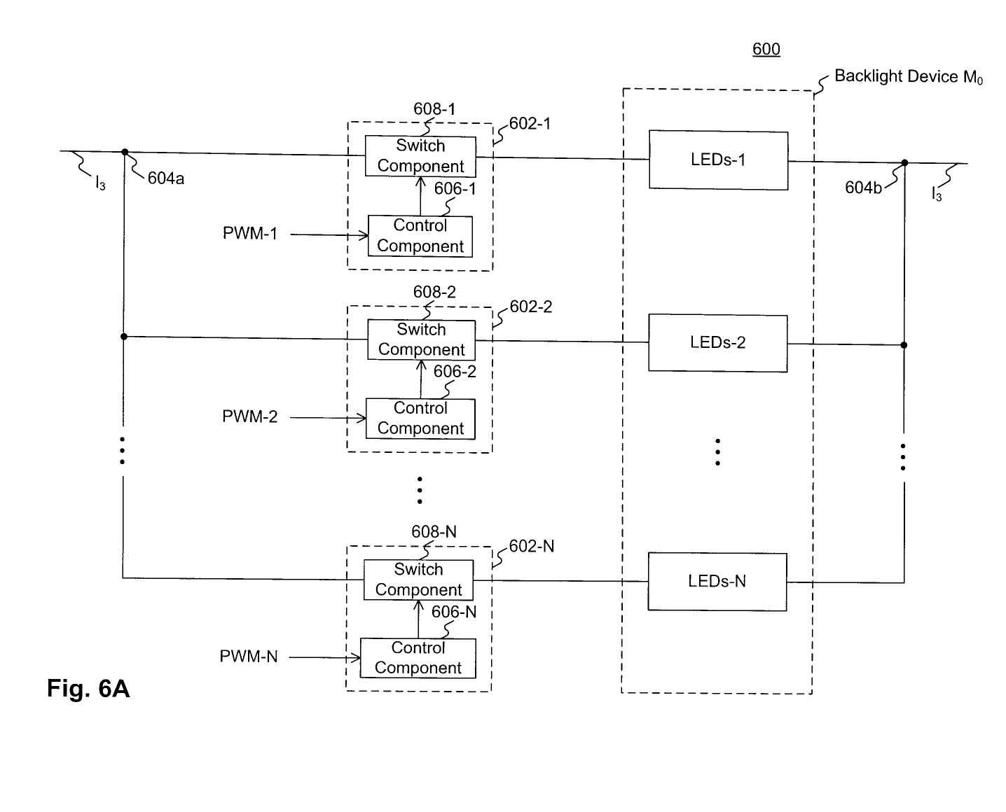

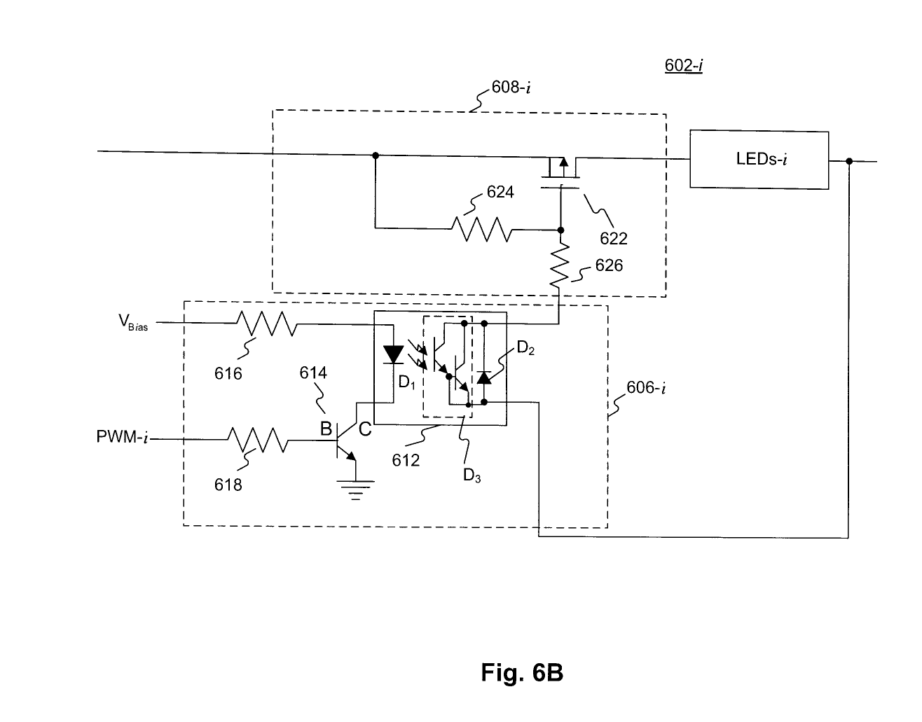

FIG. 6A illustrates a schematic block diagram of a driving module 600, according to an exemplary embodiment. The driving module 600 is an exemplary implementation of the driving module 208 in FIG. 2, and may include a plurality of LED driving units 602-1, 602-2, . . . , 602-N (N is the total number of the block areas of the video image Im₀). The LED driving units 602-1, 602-2, . . . , 602-N are configured to respectively drive the LED arrays LEDs-1, LEDs-2, . . . , and LEDs-N, based on the PWM signals PWM-1, PWM-2, . . . , PWM-N.

The driving module 600 may also include first and second power terminals 604a and 604b coupled to the alternating current rectifying circuit 212 (FIG. 2) to receive power through the current I₃. For example, the current I₃ may flow into the driving module 600 at the terminal 604a and flow out of the module 600 at the terminal 604b. Also, for example, the current I₃ may flow into the driving module 600 at the terminal 604b and flow out of the module 600 at the terminal 604a.

In one exemplary embodiment, each of the LED driving units 602-i (i=1, 2, . . . , N) may further include a control component 606-i and a switch component 608-i. For example, if the backlight device M₀ uses single-color LEDs such as white LEDs, the control component 606-i may turn on the switch component 608-i such that a current may flow through the white LED string in the array LEDs-i, when the PWM signal PWM-i has a high level. Alternatively, the control component 606-i may turn off the switch component 608-i such that the current may not flow through the white LED string in the array LEDs-i, when the PWM signal PWM-i has a low level. Also, for example, if the backlight device M₀ uses multi-color LEDs such as red, green, and blue LEDs, the control component 606-i and the switch component 608-i may control the red, green, and blue LED strings in the array LEDs-i, respectively based on the signal components R-PWM-i, G-PWM-i, and B-PWM-i of the PWM signal PWM-i.

FIG. 6B illustrates a circuit diagram of the LED driving unit 602-i, according to an exemplary embodiment. Solely for the purpose of illustration, it is assumed the backlight device M₀ uses single-color LEDs, and the LED array LEDs-i includes a string of white LEDs.

Referring to FIG. 6B, the control component 606-i may include a photoelectric converter 612 having an LED D₁, a diode D₂, and a phototransistor D₃. The control component 606-i may further include a transistor 614, and first and second resistors 616 and 618. The switch component 608-i may include a transistor 622, and first and second resistors 624 and 626.

In one exemplary embodiment, the control component 606-i receives the PWM signal PWM-i having the high level. The PWM signal PWM-i is applied at a gate or base terminal of the transistor 614. Accordingly, the transistor 614 is turned on and a first current may flow through the LED D₁ of the photoelectric converter 612. The magnitude of the first current is based on a bias voltage V_{bias} and the first resistor 616. The LED D₁ then emits light which is converted to a second current flowing through the phototransistor D₃. The second current flows through the resistor 626 and provide a bias voltage at a gate or base terminal of the transistor 622 in the switch component 608-i, based on the resistors 624 and 626. As a result, the transistor 622 is turned on and a third current flows through the white LED string in the LED array LEDs-i, which causes the white LED string to emit light.

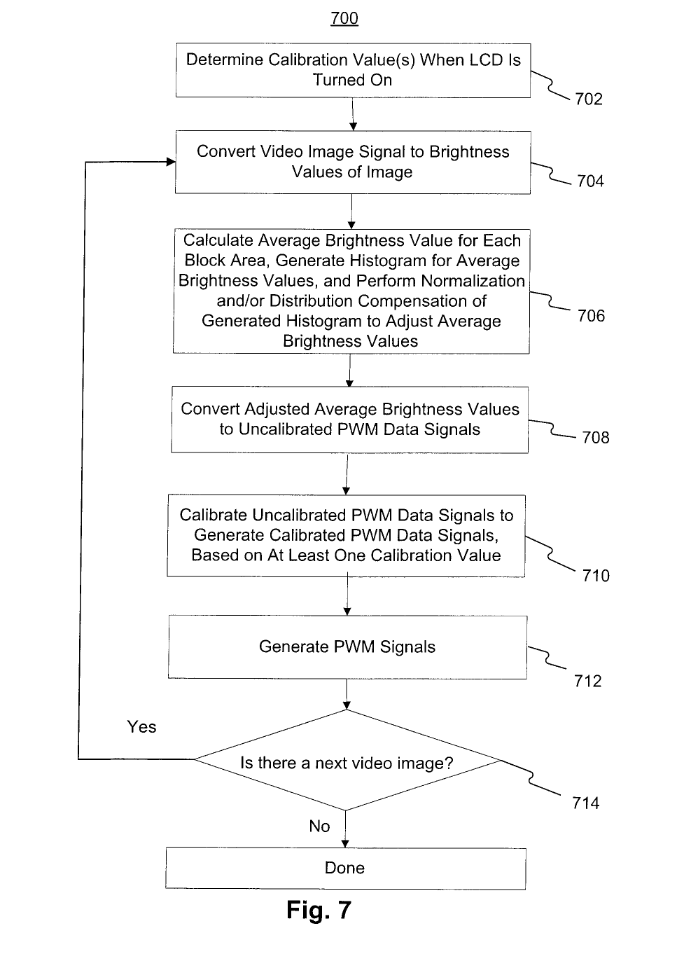

FIG. 7 illustrates a flow chart 700 of a method for the backlight control apparatus 200 (FIG. 2) to control the backlight device M₀, according to an exemplary embodiment. Referring to FIGS. 2, 4A, and 7, the photo sensor 210 senses the intensity of the light emitted by the backlight device M₀ when the LCD is turned on, and provides the feedback signal indicating the intensity. The calibration unit 406 in the image processing module 204 receives the feedback signal from the photo sensor 210 and determines at least one calibration value based on the feedback signal (step 702). For example, if the backlight device M₀ uses single-color LEDs such as white LEDs, the calibration unit 406 may generate the calibration value for the white LEDs. Also, for example, if the backlight device M₀ uses multi-color LEDs such as red, green, and blue LEDs, the calibration unit 406 may generate the first, second, and third calibration values respectively for the red, green, and blue LEDs.

Next, the image converting unit 402 in the image processing module 204 receives the video image signal Sig₀ representing the video image Im₀. The image converting unit 402 may then convert the video image signal Sig₀ to the plurality of brightness values each corresponding to a pixel of the video image Im₀, i.e., the brightness values of the video image Im₀ (step 704).

The calculation unit 404 in the image processing module 204 receives the brightness values of the video image Im₀ from the image converting unit 402. The calculation unit 404 divides the video image Im₀ into the N block areas and converts the brightness values of the video image Im₀ to the uncalibrated PWM data signals PWMDATA0-1, PWMDATA0-2, . . . , PWMDATA0-N, respectively corresponding to the block areas Block-1, Block-2, . . . , Block-N of the video image Im₀. For example, the calculation unit 404 calculates the average brightness values for the block areas Block-i (i=1, 2, . . . , N), respectively. The calculation unit 404 may further generate a histogram for the average brightness values, and perform normalization and/or distribution compensation of the generated histogram to adjust each of the average brightness values (step 706). If the backlight device M₀ uses single-color LEDs such as white LEDs, the image converting unit 402 may convert the adjusted average brightness value for the block area Block-i (i=1, 2, . . . , N) to the uncalibrated PWM data signal PWMDATA0-i directly. If the backlight device M₀ uses multi-color LEDs such as red, green, and blue LEDs, the calculation unit 404 may calculate the red, green, and blue brightness values L_{R}, L_{G}, and L_{B} for the block area Block-i (i=1, 2, . . . , N) based on the adjusted average brightness value for the block area Block-i, and then convert the red, green, blue brightness values L_{R}, L_{G}, and L_{B} to the uncalibrated PWM data signal PWMDATA0-i (step 708).

Next, the calibration unit 406 in the image processing module 204 receives the uncalibrated PWM data signals PWMDATA0-1, PWMDATA0-2, . . . , PWMDATA0-N from the calculation unit 404 and performs calibration thereof, based on the at least one calibration value noted above, to generate the calibrated PWM data signals PWMDATA-1, PWMDATA-2, . . . , PWMDATA-N (step 710). In the illustrated embodiment, the at least one calibration value is determined based on the feedback signal received from the photo sensor 210.

The control module 206 receives the PWM data signals PWMDATA-1, PWMDATA-2, . . . , PWMDATA-N, based on which the control module 206 generates the PWM signals PWM-1, PWM-2, . . . , PWM-N (step 712). The driving module 208 then receives the PWM signals PWM-1, PWM-2, . . . , PWM-N and uses the PWM signals PWM-1, PWM-2, . . . , PWM-N to respectively drive the LED arrays LEDs-1, LEDs-2, LEDs-N, such that the video image Im₀ may be displayed on the LCD.

The backlight control apparatus 200 judges whether it receives a next video image signal Sig₁ representing a next video image Im₁ (step 714). If the backlight control apparatus 200 determines that it receives the next video image signal Sig₁, steps 704-714 are repeated.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A backlight control apparatus for controlling a backlight device for a liquid crystal display (LCD), the backlight device including a plurality of light-emitting components, the backlight control apparatus comprising:
a synchronization unit to provide a synchronization signal;
an image processing module to receive a video image signal representing a video image, the image processing module being configured to divide the video image into a plurality of block areas and generate a plurality of pulse-width modulation (PWM) data signals each corresponding to one of the plurality of block areas;
a control module coupled to the synchronization unit and the image processing module, the control module being configured to generate a plurality of PWM signals based on the plurality of PWM data signals and the synchronization signal; and
a driving module coupled to the control module, the driving module being configured to drive the backlight device based on the plurality of PWM signals.

2. The backlight control apparatus of claim 1, wherein each of the plurality of light-emitting components is a light-emitting diode (LED).

3. The backlight control apparatus of claim 1, wherein the backlight control apparatus is configured to be powered by an alternating current power source, and further comprises an alternating current rectifying circuit to rectify an alternating current provided by the alternating current power source.

4. The backlight control apparatus of claim 3, wherein the synchronization unit comprises a filter and a comparator to generate the synchronization signal.

5. The backlight control apparatus of claim 1, wherein the plurality of PWM data signals is a first plurality of PWM data signals, the image processing module comprising:
an image converting unit configured to receive the video image signal;
a calculation unit coupled to the image converting unit and configured to calculate a second plurality of PWM data signals each corresponding to one of the plurality of block areas; and
a calibration unit coupled to the calculation unit and configured to calibrate the second plurality of PWM data signals to generate the first plurality of PWM data signals.

6. The backlight control apparatus of claim 5, wherein the image converting unit is configured to convert the video image signal to a plurality of brightness values each for a pixel of the video image.

7. The backlight control apparatus of claim 5, wherein the calculation unit comprises a memory device.

8. The backlight control apparatus of claim 5, wherein the calculation unit comprises:
a timing generator configured to generate a timing signal;
a plurality of data averaging components each coupled to the image converting unit and the timing generator, the plurality of data averaging components being configured to calculate a plurality of average brightness values each for one of the plurality of block areas; and
a data processing component coupled to the plurality of data averaging components and the timing generator, the data processing component being configured to generate the second plurality of PWM data signals based on the plurality of average brightness values.

9. The backlight control apparatus of claim 8, wherein the data processing component is configured to process the plurality of average brightness values to generate a plurality of adjusted brightness values each for one of the plurality of block areas.

10. The backlight control apparatus of claim 9, wherein the data processing component is configured to generate the plurality of adjusted brightness values by generating a histogram for the plurality of average brightness values, and performing normalization and distribution compensation of the histogram.

11. The backlight control apparatus of claim 9, wherein the data processing component is configured to generate the second plurality of PWM data signals based on the plurality of adjusted brightness values.

12. The backlight control apparatus of claim 9, wherein the data processing component is configured to generate the second plurality of PWM data signals based on a look-up table.

13. The backlight control apparatus of claim 5, further comprising a photo sensor configured to sense intensity of light emitted by the backlight device and to provide a feedback signal based on the intensity of the emitted light for the calibration unit.

14. The backlight control apparatus of claim 13, wherein the calibration unit is configured to generate at least one calibration value based on the feedback signal and calibrate the second plurality of PWM data signals based on the at least one calibration value.

15. The backlight control apparatus of claim 1, wherein the control module is configured to generate the plurality of PWM signals each having a duty cycle value associated with a value of one of the plurality of PWM data signals.

16. The backlight control apparatus of claim 15, wherein the control module comprises a plurality of PWM signal generators, each of the plurality of PWM signal generators being configured to generate one of the plurality of PWM signals.

17. The backlight control apparatus of claim 1, wherein the driving module comprises a plurality of driving units, each of the plurality of driving units being configured to receive one of the plurality of PWM signals to drive ones of the plurality of light-emitting components corresponding to one of the plurality of block areas.

18. The backlight control apparatus of claim 17, wherein the driving unit comprises:
a control component to receive the one of the plurality of PWM signals, the control component being configured to provide a first current based on the one of the plurality of PWM signals; and
a switch component coupled to the control component, the switch component being configured to provide a second current for the ones of the plurality of light-emitting components based on the first current.

19. The backlight control apparatus of claim 18, wherein the control component comprises:
a transistor to receive the one of the plurality of PWM signals, the transistor being configured to provide a third current based on the one of the plurality of PWM signals;
a photoelectric converter coupled to the transistor and configured to provide the first current based on the third current.

20. The backlight control apparatus of claim 18, wherein the switch component comprises a transistor configured to provide the second current based on the first current.

21. A method for controlling a backlight device to display a video image on a liquid crystal display (LCD), the backlight device including a plurality of light-emitting components, the method comprising:
dividing the video image into a plurality of block areas;
determining a plurality of brightness values each for one of the plurality of block areas;
generating a plurality of pulse-width modulation (PWM) signals each corresponding to one of the plurality of block areas, based on the plurality of brightness values; and
controlling the backlight device based on the plurality of PWM signals, wherein each of the plurality of PWM signals controls ones of the plurality of light-emitting components corresponding to one of the plurality of block areas.

22. The method of claim 21, wherein the determining comprises:
calculating a plurality of average brightness values each for one of the plurality of block areas; and
adjusting the plurality of average brightness values to generate the plurality of brightness values.

23. The method of claim 22, wherein the adjusting comprises:
generating a histogram for the plurality of average brightness values; and
performing normalization and distribution compensation of the histogram.

24. The method of claim 21, wherein the generating comprises:
generating a plurality of PWM data signals each corresponding to one of the block areas, based on the plurality of brightness values; and
generating the plurality of PWM signals based on the plurality of PWM data signals;
wherein each of the plurality of PWM signals has a duty cycle value associated with a value of one of the plurality of PWM data signals.

25. The method of claim 24, wherein the generating of the plurality of PWM data signals comprises:
determining at least one calibration value based on intensity of light emitted by the backlight device; and
generating the plurality of PWM data signals based on the at least one calibration value.
